(19) United States
(12) Patent Application Publication
(10) Pub. No.: US 2022/0229215 A1
(43) Pub. Date: Jul. 21, 2022

(54) RADIATION SUPPRESSION FILM AND RADIATION SUPPRESSION STRUCTURE

(71) Applicant: NEC Corporation, Minato-ku, Tokyo (JP)

(72) Inventors: Taizo SHIBUYA, Tokyo (JP); Akinobu SHIBUYA, Tokyo (JO)

(73) Assignee: NEC Corporation, Minato-ku, Tokyo (JP)

(21) Appl. No.: 17/609,050

(22) PCT Filed: May 20, 2020
(86) PCT No.: PCT/JP2020/019843

§ 371 Date: Nov. 5, 2021

(30) Foreign Application Priority Data
May 29, 2019 (JP) 2019-100505

(51) Int. Cl. G02B 5/22; G02B 5/20; C08K 3/08; C08K 3/105

(52) U.S. Cl. CPC G02B 5/22; C08K 3/105; C08K 3/08; G02B 5/208

(57) ABSTRACT

A radiation suppression film includes a porous body containing a material transparent to a long wavelength infrared ray as a base material.

### TECHNICAL FIELD

The present invention relates to a radiation suppression film and a radiation suppression structure that suppress radiation of a long wavelength infrared ray radiated from a surface of an object.

### BACKGROUND ART

With the progress of detection techniques, an object such as a vehicle or a flying object can be detected using electromagnetic waves of various wavelengths. For example, a detection technique using a long wavelength infrared ray having a wavelength of 8 to 14 micrometers (μm) radiated from a heat source having a temperature around room temperature has been developed. By using the detection technique using a long wavelength infrared ray, even an object having enhanced stealth to radio waves can be detected. Meanwhile, there is a demand for stealth techniques and disturbing techniques against the detection technique using a long wavelength infrared ray. For example, if long wavelength infrared radiation radiated from an object can be suppressed, it becomes difficult to detect the object even if a long wavelength infrared ray is used.

PTL 1 discloses a thermal camouflage laminate. The thermal camouflage laminate of PTL 1 has a structure in which a layer containing metal and polyethylene is laminated on a surface of a fabric or the like. According to the thermal camouflage laminate of PTL 1, emissivity of a mid-infrared ray in a wavelength region of 3 to 5 μm and emissivity of a long wavelength infrared ray in a wavelength region of 8 to 14 μm can be suppressed to a range of 0.4 to 0.95.

PTL 2 discloses a camouflage combat jacket having a surface of a fabric on which a metal material is processed, and a camouflage print of three or more colors applied to the processed surface. The camouflage combat jacket of PTL 2 is characterized in that area-weighted average radiation power of a clothing surface is 0.4 to 0.85, and a difference in maximum radiation power between the colors is 0.1 to 0.6.

In the techniques disclosed in PTLs 1 and 2, metal having high reflectance and low emissivity is used in a long wavelength infrared region. Since the metal has high reflectance in the long wavelength infrared region, thermal radiation from an object or a human body covered with a fabric is suppressed. Further, since the metal has small emissivity in its own long wavelength infrared region, the thermal radiation is suppressed.

### CITATION LIST

### Patent Literature

[PTL 1] U.S. Pat. No. 4,529,633
[PTL 2] JP 2004-053039 A

### SUMMARY OF INVENTION

### Technical Problem

Since an object of the techniques disclosed in PTLs 1 and 2 is to cause an object serving as a heat source to be blended in nature, it is sufficient that the emissivity of the surface of the object is equal to or more than 0.4. However, when the emissivity is equal to or more than 0.4, there is a possibility that the surface of the object heated by sunlight to have a high temperature is detected. If the emissivity can be suppressed to less than 0.4, the stealth with respect to the detection technique using a long wavelength infrared ray can be improved but since suppression of the emissivity to less than 0.4 is difficult, there is a possibility that detection is performed by the detection technique using a long wavelength infrared ray.

An object of the present invention is to solve the above-described problem and provide a radiation suppression film that suppresses infrared radiation having a wavelength within a long wavelength infrared region and is less easily detected by a detection technique using a long wavelength infrared ray.

### Solution to Problem

A radiation suppression film according to one aspect of the present invention includes a porous body containing a material transparent to a long wavelength infrared ray as a base material.

A radiation suppression structure according to one aspect of the present invention includes a substrate and a radiation suppression film including a porous body in which holes are dispersed in a base material formed on at least a part of a surface of the substrate and containing a material transparent to a long wavelength infrared ray.

### Advantageous Effects of Invention

According to the present invention, a radiation suppression film that suppresses infrared radiation having a wavelength within a long wavelength infrared region and is less easily detected by a detection technique using a long wavelength infrared ray can be provided.

### BRIEF DESCRIPTION OF DRAWINGS

FIG. 1 is a conceptual diagram illustrating an example of a cross section of a radiation suppression structure including a radiation suppression film according to a first example embodiment of the present invention.

FIG. 2 is a conceptual diagram illustrating an example of a cross section of a radiation suppression structure including a radiation suppression film according to a second example embodiment of the present invention.

FIG. 3 is a conceptual diagram illustrating an example of a cross section of a radiation suppression structure including a radiation suppression film according to a third example embodiment of the present invention.

FIG. 4 is a conceptual diagram illustrating an example of a cross section of a radiation suppression structure including a radiation suppression film according to a fourth example embodiment of the present invention.

FIG. 5 is a conceptual diagram illustrating an example of a cross section of a radiation suppression structure including a radiation suppression film according to a fifth example embodiment of the present invention.

FIG. 6 is a conceptual diagram illustrating an example of a cross section of a radiation suppression structure including a radiation suppression film according to a sixth example embodiment of the present invention.

### EXAMPLE EMBODIMENT

Hereinafter, forms for implementing the present invention will be described with reference to the drawings. The example embodiments to be described below have technically favorable limitations for implementing the present invention. However, the scope of the invention is not limited to below. In all the drawings used in the following description of the example embodiments, the same reference numerals are given to the same parts unless there is a particular reason. In the following example embodiments, repeated description of similar configurations and operations may be omitted.

### First Example Embodiment

First, a radiation suppression film according to a first example embodiment of the present invention will be described with reference to the drawing. The radiation suppression film of the present example embodiment suppresses radiation of infrared light (hereinafter also referred to as a long wavelength infrared ray) in a long wavelength infrared region. In particular, the radiation suppression film of the present example embodiment suppresses radiation of a long wavelength infrared ray having a wavelength of 8 to 14 micrometers (μm). When a surface of an object is covered with the radiation suppression film of the present example embodiment, leakage of the long wavelength infrared ray radiated from the object to an outside is suppressed. Hereinafter, a configuration in which the radiation suppression film of the present example embodiment is laminated on a surface of an object (hereinafter referred to as a substrate) will be described.

### [Structure]

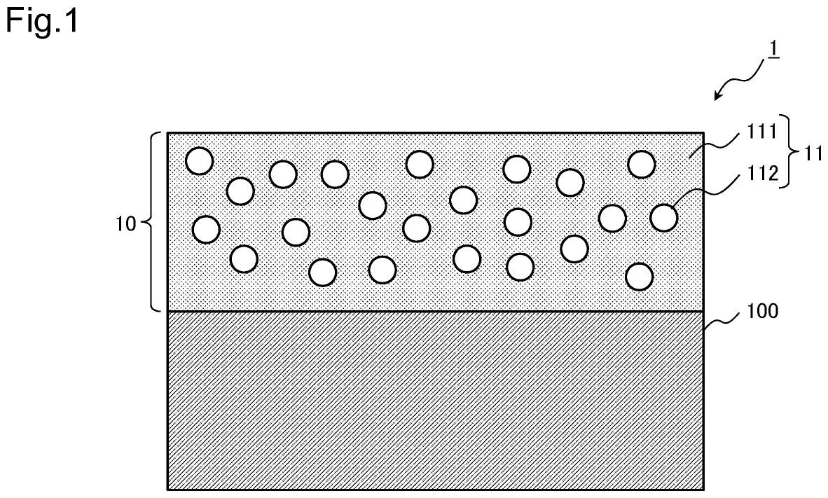

FIG. 1 is a conceptual diagram illustrating an example of a cross section of a radiation suppression structure 1 including a radiation suppression film 10 according to the present example embodiment. The radiation suppression film 10 is formed on a surface of a substrate 100. The radiation suppression film 10 has a porous body 11 in which holes 112 are dispersed in a base material 111. A plurality of holes 112 is dispersed in the porous body 11. The radiation suppression structure 1 is a structure in which the radiation suppression film 10 is formed on a surface portion of the substrate 100. In the present example embodiment, since the porous body 11 itself in which the holes 112 are dispersed in the base material 111 constitutes the radiation suppression film 10, the porous body 11 itself corresponds to the radiation suppression film 10.

The base material 111 contains a material transparent to the long wavelength infrared ray. The material transparent to the long wavelength infrared ray is a material having high transmittance of the long wavelength infrared ray.

For example, a chalcogenide compound such as zinc selenide (ZnSe) or zinc sulfide (ZnS) can be used as the base material 111. Further, for example, germanium (Ge) can be used as the base material 111. Further, for example, polyethylene can be used as the base material 111. The base material 111 may be a single material or a combination of a plurality of materials. Further, an additive that is not transparent to the long wavelength infrared ray may be mixed with the base material 111. The transmittance of the long wavelength infrared ray of the material of the base material 111 is favorably equal to or more than 40%. The transmittance of the long wavelength infrared ray of the material of the base material 111 is more favorably equal to or more than 60% at a thickness of 5 mm.

Emissivity ε is calculated by the following equation 1 using a measured value of black-body radiation intensity I_{b} and a measured value of radiation intensity Iₑ of a sample (λ: wavelength and T: absolute temperature):

ε(λ,T)=Iₑ(λ,T)/I_{b}(λ,T) (1)

Absorptivity α is calculated by the following equation 2 using reflectance R and transmittance T:

α(λ,T)=1−the reflectance R(λ,T)−the transmittance T(λ,T) (2)

The emissivity ε is equivalent to the absorptivity α. Therefore, the emissivity ε is calculated by the following equation 3:

ε(λ,T)=1−the reflectance R(λ,T)−the transmittance T(λ,T) (3)

For example, ZnSe is used as a window material for the infrared ray, and the transmittance T of the long wavelength infrared ray of a bulk material not including holes is about 70% (0.7) at a thickness of 5 mm. The window material for ZnSe to which surface treatment has not been applied has high reflectance R and high transmittance T on the surface. When the reflectance R and the transmittance T of ZnSe are applied to the equation 2, the emissivity ε is smaller than 0.3 because the transmittance T is 0.7.

In the techniques disclosed in PTL 1 (U.S. Pat. No. 4,529,633) and PTL 2 (Japanese Patent Application Laid-Open No. 2004-053039), a lower limit value of the emissivity ε is 0.4. In the case where the emissivity ε is equal to or more than 0.4, there is a possibility that the surface of the object is heated by sunlight to have a high temperature, and the object is detected using the long wavelength infrared ray. Therefore, the emissivity ε is favorably less than 0.4, but it is difficult to make the emissivity ε less than 0.4 with the techniques of PTLs 1 and 2.

In contrast, by using the radiation suppression film 10 including the porous body 11 in which the holes 112 are dispersed in the base material 111 containing a material transparent to the long wavelength infrared ray, the long wavelength infrared ray radiated from the surface of the substrate 100 is scattered by the holes 112. A part of the long wavelength infrared ray scattered by the holes 112 is reabsorbed by the surface of the substrate 100 and converted into heat. Therefore, the long wavelength infrared ray radiated from the surface of the substrate 100 to the outside is reduced. Further, since the base material 111 has high transparency in the long wavelength infrared region, thermal radiation of the base material 111 itself in the long wavelength infrared region is small. Since these effects are synergized, the emissivity of the long wavelength infrared ray from the surface of the substrate 100 can be made less than 0.4 by covering the surface of the substrate 100 with the radiation suppression film 10. For example, when ZnSe is used as the base material 111 of the radiation suppression film 10, the emissivity ε of bulk ZnSe not including holes is less than 0.3, and thus it is not difficult to make the emissivity of the radiation suppression film 10 less than 0.4.

The thickness of the base material 111 is set to be larger than the wavelength in the long wavelength infrared region. The thickness of the base material 111 is favorably 10 times or more the wavelength in the long wavelength infrared region. Further, the thickness of the base material 111 is more favorably equal to or more than 500 μm.

The hole 112 is a gap formed inside the base material 111. The hole 112 may be formed not only inside the base material 111 but also in the surface of the base material 111. FIG. 1 illustrates the hole 112 as being spherical but the actual shape of the hole 112 is not particularly limited. The shapes of the holes 112 may be uniform or may be various shapes. The size of the hole 112 is not particularly limited but the hole is favorably formed into a size large enough to scatter the long wavelength infrared ray.

When the long wavelength infrared ray radiated from the substrate 100 and traveling inside the base material 111 collides with the hole 112, the long wavelength infrared ray is scattered at an interface between the base material 111 and the hole 112. When increasing the opportunity of scattering of the long wavelength infrared ray radiated from substrate 100, the long wavelength infrared ray radiated from the surface of radiation suppression film 10 can be reduced. Therefore, it is favorable to increase the opportunity to backscatter the long wavelength infrared ray toward the substrate 100 by causing the long wavelength infrared ray to collide with the holes 112.

A ratio of a volume of the holes 112 to a total volume of the base material 111 is porosity. The porosity is not particularly limited as long as the long wavelength infrared ray radiated from the surface of the radiation suppression film 10 can be suppressed. However, when the porosity is too small, a frequency at which the long wavelength infrared ray radiated from the substrate 100 is scattered by the holes 112 decreases. Therefore, when the porosity is too small, the long wavelength infrared ray radiated from the substrate 100 is radiated from the surface of the radiation suppression film 10 without being scattered, and a sufficient radiation suppression effect cannot be obtained. Meanwhile, when the porosity is too large, mechanical strength of the radiation suppression film 10 becomes weak and becomes brittle. Therefore, the porosity is favorably set within a specific range. For example, when the porosity is set to 20 to 70%, the sufficient radiation suppression effect and mechanical strength can be obtained.

The substrate 100 is an object having the radiation suppression film 10 formed on its surface. The material of the substrate 100 is not particularly limited as long as the radiation suppression film 10 can be formed on the surface. For example, metal, ceramic, plastic, or the like can be applied to the substrate 100.

The substrate 100 is a surface portion of an object to be concealed with respect to detection using the long wavelength infrared ray. For example, a surface portion of an object such as a vehicle or a flying object corresponds to the substrate 100. When the surface portion (substrate 100) of the object such as a vehicle or a flying object is covered with the radiation suppression film 10, the long wavelength infrared ray radiated from the surface of the object can be reduced, so that the object can be concealed from detection using the long wavelength infrared ray.

### [Manufacturing Method]

Next, a method for manufacturing the radiation suppression film 10 will be described with an example. For example, the radiation suppression film 10 can be manufactured using an aerosol deposition method, a cold spraying method, a plasma spraying method, a sol-gel method, or the like.

In the case of using the aerosol deposition method, the radiation suppression film 10 can be formed by blowing aerosolized fine particles of the base material 111 onto the surface of the substrate 100 at a high speed and performing room temperature impact consolidation. The porosity and a hole size of the radiation suppression film 10 can be controlled by adjusting a particle diameter of fine particles of the base material 111 and a blowing speed. The aerosol deposition method is suitable for the base material 111 containing a hard material such as ZnSe or ZnS.

For example, when fine particles of ZnS are formed into an aerosol and blown onto the surface of the stainless steel substrate 100 and room temperature impact consolidation is performed, the radiation suppression film 10 constituted by the ZnS porous body 11 can be formed on the surface of the stainless steel substrate 100.

Further, the radiation suppression film 10 may be formed by fixing a block formed by sintering fine particles of the base material 111 to the surface of substrate 100 with an adhesive or the like. In this case, the porosity and the hole size can be controlled by adjusting the particle diameter of the fine particles, a sintering temperature, and a sintering time.

The above is the description of the radiation suppression film 10 of the present example embodiment. The structure of FIG. 1 is an example, and the structure of the radiation suppression film 10 is not limited to the form as in FIG. 1. For example, the radiation suppression film 10 may be formed not on a flat surface but on a curved surface. The radiation suppression film 10 may be formed not on a smooth surface but on a surface having irregularities. The radiation suppression film 10 may be continuously or discontinuously formed on at least one surface of substrate 100. The radiation suppression film 10 may be formed on surfaces of the different substrates 100 so as to straddle a boundary between the substrates 100. The radiation suppression film 10 may be formed on the surface of the substrate of not only metal but also ceramic or plastic.

For example, when the radiation suppression film 10 is formed on the surface of the object such as a vehicle or a flying object, concealment of the object with respect to a search using the long wavelength infrared ray is improved. Further, when the radiation suppression film 10 is formed on an upper surface of a radio wave absorber or a radio wave scatterer, scattering of radio waves can be prevented, so that the concealment can be further improved. The radiation suppression film 10 of the present example embodiment is not limited to the above application, and can be used for any application intended to prevent the long wavelength infrared ray radiated from the object from leaking to the outside.

As described above, the radiation suppression film according to the present example embodiment includes the porous body containing the material transparent to the long wavelength infrared ray as the base material. In other words, the radiation suppression film of the present example embodiment includes the porous body in which the holes are dispersed in the base material containing a material transparent to the long wavelength infrared ray. In one aspect of the present example embodiment, the material of the base material contains at least one of materials selected from the group of ZnSe, ZnS, and Ge. In one aspect of the present example embodiment, the material of the base material contains polyethylene. In one aspect of the present example embodiment, the radiation suppression film is constituted by a layer of the porous body.

Furthermore, the radiation suppression structure according to one aspect of the present example embodiment includes the radiation suppression film including the porous body in which the holes are dispersed in the base material formed on at least a part of the surface of the substrate and containing a material transparent to the long wavelength infrared ray, and the substrate.

According to the radiation suppression film of the present example embodiment, the long wavelength infrared ray radiated from the surface of the object is scattered by the holes, and a part of the long wavelength infrared ray is reabsorbed by the surface of the object and converted into heat. Therefore, the long wavelength infrared ray radiated from the surface of the object to the outside is reduced. Further, since the base material has high transparency in the long wavelength infrared region, thermal radiation of the base material itself in the long wavelength infrared region is small. Since these effects are synergized, when the surface of the object is covered with the radiation suppression film of the present example embodiment, the emissivity of the long wavelength infrared ray from the surface of the object can be reduced to less than 0.4.

That is, according to the radiation suppression film of the present example embodiment, infrared radiation having the wavelength within the long wavelength infrared region is suppressed and the radiation suppression film can be made less easily detected by a detection technique using a long wavelength infrared ray.

### Second Example Embodiment

Next, a radiation suppression film according to a second example embodiment of the present invention will be described with reference to the drawing. The radiation suppression film of the present example embodiment has a structure in which the porous body included in the radiation suppression film of the first example embodiment is dispersed inside a resin. Hereinafter, description of structures, functions, and the like similar to those of the first example embodiment may be omitted.

[Structure]

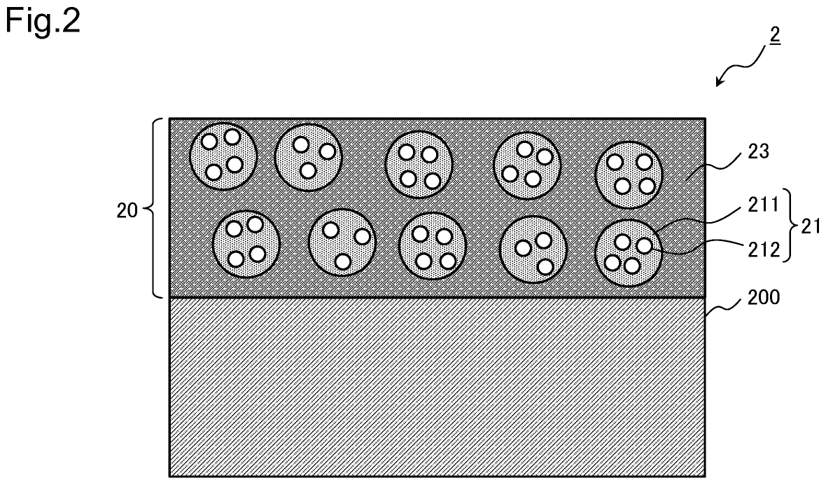

FIG. 2 is a conceptual diagram illustrating an example of a cross section of a radiation suppression structure 2 including a radiation suppression film 20 according to the present example embodiment. The radiation suppression film 20 is formed on a surface of a substrate 200. The radiation suppression film 20 has a structure in which porous bodies 21 in each of which holes 212 are dispersed inside a base material 211 are dispersed inside a resin 23. The radiation suppression structure 2 is a structure in which a radiation suppression film 20 is formed on a surface portion of the substrate 200. In the present example embodiment, the radiation suppression film 20 is constituted by the porous bodies 21 in each of which the holes 212 are dispersed inside the base material 211 and the resin 23 in which the porous bodies 21 are dispersed.

The base material 211 contains a material transparent to a long wavelength infrared ray, similar to the base material 111 of the first example embodiment. The material transparent to the long wavelength infrared ray is a material having high transmittance of the long wavelength infrared ray. Characteristics such as the material and physical properties of the base material 211 are similar to those of the base material 111 of the first example embodiment. The base material 211 is dispersed inside the resin 23. The base material 211 may be not only dispersed inside the resin 23 but also exposed to a surface of the radiation suppression film 20. The size and shape of the base material 211, the dispersion state in the resin 23, and the like are not particularly limited, but it is favorable to form the base material 211 and the resin 23 such that the long wavelength infrared ray can be easily scattered.

The hole 212 is a gap formed inside the base material 211, similarly to the hole 112 of the first example embodiment. The properties of the hole 212 are similar to those of the hole 112 of the first example embodiment.

The resin 23 is a base including the porous bodies 21 each having the dispersed holes 212 inside the base material 211. The resin 23 contains a material transparent to the long wavelength infrared ray. For example, polyethylene can be used as the resin 23. The thickness of the resin 23 is made larger than a wavelength in a long wavelength infrared region. The thickness of the resin 23 is favorably 10 times or more the wavelength in the long wavelength infrared region. Further, the thickness of the resin 23 is more favorably equal to or more than 500 μm.

When the long wavelength infrared ray radiated from the substrate 200 and traveling inside the resin 23 collides with the porous body 21 or the hole 212 inside the porous body 21, the long wavelength infrared ray is scattered at an interface between the resin 23 and the porous body 21 or an interface between the base material 211 and the hole 212. When increasing the opportunity of scattering of the long wavelength infrared ray radiated from substrate 200, the long wavelength infrared ray radiated from the surface of radiation suppression film 20 can be reduced. Therefore, it is favorable to increase the opportunity to backscatter the long wavelength infrared ray toward the substrate 200 by causing the long wavelength infrared ray to collide with the porous bodies 21 and the holes 212.

A ratio of a volume of the porous bodies 21 to a total volume of the resin 23 (hereinafter referred to as a ratio of the porous bodies 21) is not particularly limited as long as the long wavelength infrared ray radiated from the surface of the radiation suppression film 20 can be suppressed. However, when the ratio of the porous bodies 21 is too small, a frequency at which the long wavelength infrared ray radiated from the substrate 200 is scattered by the ratio of the porous bodies 21 decreases. Therefore, when the ratio of the porous bodies 21 is too small, the long wavelength infrared ray radiated from the substrate 200 is radiated from the surface of the radiation suppression film 20 without being scattered, and a sufficient radiation suppression effect cannot be obtained. Meanwhile, when the ratio of the porous bodies 21 is too large, the amount of the resin is insufficient, and the porous bodies cannot maintain a film structure. Therefore, the ratio of the porous bodies 21 is favorably set within a specific range.

The substrate 200 is an object having the radiation suppression film 20 formed on its surface, similar to the substrate 100 of the first example embodiment.

[Manufacturing Method]

Next, a method for manufacturing the radiation suppression film 20 will be described with an example. For example, the radiation suppression film 20 can be manufactured by applying the resin 23 in which the porous bodies 21 each having the holes 212 dispersed inside the base material 211 are dispersed.

First, fine particles of the base material 211 are sintered to produce a sintered body of the porous body 21. Porosity and hole size of the sintered body of the porous body 21 can be controlled by adjusting a particle diameter of the fine particles, a sintering temperature, and a sintering time. Next, the sintered body of the porous body 21 is pulverized to produce particles of the porous body 21. Next, the particles of the porous body 21 and the resin 23 are mixed to produce a coating material in which the particles of the porous body 21 are dispersed in the resin 23. Then, the coating material in which the particles of the porous body 21 are dispersed in the resin 23 is applied to the surface of the substrate 200 by a flow immersion method or the like and consolidated, so that the radiation suppression film 20 can be formed on the surface of the substrate 200.

For example, a ZnS porous body 21 is produced by pulverizing a porous sintered body obtained by sintering fine particles of ZnS. Further, a coating material is prepared by mixing the ZnS porous body 21 with the polyethylene resin 23. The radiation suppression film 20 in which the ZnS porous bodies 21 are dispersed in the polyethylene resin 23 can be formed on the surface of the substrate 200 made of stainless steel by applying the coating material to the surface of the substrate 200 made of stainless steel using a flow immersion method and consolidating the coating material.

The above is the description of the radiation suppression film 20 of the present example embodiment. The structure of FIG. 2 is an example, and the structure of the radiation suppression film 20 is not limited to the form as in FIG. 2. For example, the radiation suppression film 20 may be formed not on a flat surface but on a curved surface. The radiation suppression film 20 may be formed not on a smooth surface but on a surface having irregularities. The radiation suppression film 20 may be continuously or discontinuously formed on at least one surface of substrate 200. The radiation suppression film 20 may be formed on surfaces of the different substrates 200 so as to straddle a boundary between the substrates 200.

Since the radiation suppression film 20 can be easily formed even on a surface having a complicated shape because of using the resin 23 as the base material. When the radiation suppression film 20 is formed into a film shape, the radiation suppression film 20 does not need to be brought into close contact with the surface of the substrate 200. Therefore, a radiation suppression effect of the long wavelength infrared ray can be obtained even in the case where it is difficult to bring the radiation suppression film 20 into close contact with the surface of substrate 200.

Further, a material that is not transparent to the long wavelength infrared ray may be added to the resin 23 as long as transmittance of the long wavelength infrared ray is not significantly reduced. For example, to improve moldability, a material that is not transparent to the long wavelength infrared ray may be mixed with the resin 23. For example, to obtain an effect other than the radiation suppression effect of long wavelength infrared ray, a material that is not transparent to the long wavelength infrared ray may be mixed with the resin 23.

As described above, the radiation suppression film of the present example embodiment has the structure in which the porous body having a material transparent to the long wavelength infrared ray as the base material is dispersed inside the resin containing the material transparent to the long wavelength infrared ray. In one aspect of the present example embodiment, the material of the resin contains polyethylene. In one aspect of the present example embodiment, the radiation suppression film is formed in a film shape.

According to the radiation suppression film of the present example embodiment, the long wavelength infrared ray radiated from the surface of an object is scattered by the porous bodies and holes, and a part of the long wavelength infrared ray is reabsorbed by the surface of the object and converted into heat. Therefore, the long wavelength infrared ray radiated from the surface of the object to the outside is reduced. Further, since the resin and the base material have high transparency in the long wavelength infrared region, thermal radiation of the resin itself and the base material itself in the long wavelength infrared region is small. Since these effects are synergized, when the surface of the object is covered with the radiation suppression film of the present example embodiment, the emissivity of the long wavelength infrared ray from the surface of the object can be reduced to less than 0.4.

That is, according to the radiation suppression film of the present example embodiment, infrared radiation having the wavelength in the long wavelength infrared region can be suppressed. Moreover, since the radiation suppression film of the present example embodiment contains the resin as a base, the radiation suppression film can be more easily formed on the surface of the substrate than the radiation suppression film of the first example embodiment.

### Third Example Embodiment

Next, a radiation suppression film according to a third example embodiment of the present invention will be described with reference to the drawing. The radiation suppression film of the present example embodiment includes an infrared-ray absorption layer. Hereinafter, description of structures, functions, and the like similar to those of the first example embodiment may be omitted.

[Structure]

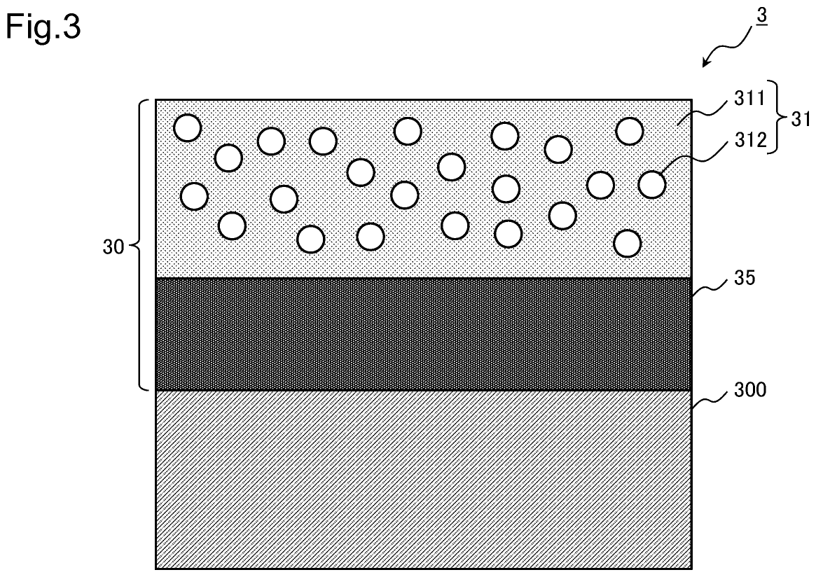

FIG. 3 is a conceptual diagram illustrating an example of a cross section of a radiation suppression structure 3 including a radiation suppression film 30 according to the present example embodiment. A radiation suppression film 30 including a porous body 31 and an infrared-ray absorption layer 35 is formed on a surface of a substrate 300. The porous body 31 has a structure in which holes 312 are dispersed inside a base material 311, similarly to the porous body 11 of the first example embodiment. The radiation suppression structure 3 has a structure in which the infrared-ray absorption layer 35 is formed on a surface portion of the substrate 300, and the porous body 31 is formed on a surface of the infrared-ray absorption layer 35. In the present example embodiment, the radiation suppression film 30 is constituted by the porous body 31 having the holes 312 dispersed inside the base material 311 and the infrared-ray absorption layer 35.

The base material 311 contains a material transparent to a long wavelength infrared ray, similar to the base material 111 of the first example embodiment. The material transparent to the long wavelength infrared ray is a material having high transmittance of the long wavelength infrared ray. Characteristics such as the material and physical properties of the base material 311 are similar to those of the base material 111 of the first example embodiment.

The hole 312 is a gap formed inside the base material 311, similarly to the hole 112 of the first example embodiment. The properties of the hole 312 are similar to those of the hole 112 of the first example embodiment.

The infrared-ray absorption layer 35 is formed on the surface of the substrate 300. The porous body 31 is formed on an upper surface of the infrared-ray absorption layer 35. The infrared-ray absorption layer 35 is an absorption layer that absorbs the long wavelength infrared ray. For example, a material having high long wavelength infrared absorptivity such as a black body coating material or a carbon material is used for the infrared-ray absorption layer 35. The material of the infrared-ray absorption layer 35 is not particularly limited as long as the material can absorb the long wavelength infrared ray radiated from the substrate 300 and the long wavelength infrared ray backscattered from the porous body 31.

The substrate 300 is an object having the radiation suppression film 30 formed on its surface, similar to the substrate 100 of the first example embodiment. The infrared-ray absorption layer 35 is formed on the surface of the substrate 300.

[Manufacturing Method]

Next, a method for manufacturing the radiation suppression film 30 will be described with an example. For example, the radiation suppression film 30 can be manufactured by forming a layer of the porous body 31 on the surface of substrate 300 on which the infrared-ray absorption layer 35 is formed. Hereinafter, an example of laminating the porous body 31 on the infrared-ray absorption layer 35 using an aerosol deposition method will be described.

First, a coating material containing a material that absorbs the long wavelength infrared ray, such as a black body coating material, is applied to the surface of the substrate 300 to form the infrared-ray absorption layer 35. Then, the radiation suppression film 30 can be formed by blowing aerosolized fine particles of the base material 311 onto the surface of the substrate 300 on which the infrared-ray absorption layer 35 has been formed at a high speed and performing room temperature impact consolidation. Porosity and hole size of the porous body 31 can be controlled by adjusting a particle diameter of the fine particles of the base material 311 and a blowing speed.

For example, the infrared-ray absorption layer 35 is formed by applying a black body coating material to the surface of the stainless steel substrate 300. Then, when fine particles of ZnS are formed into an aerosol and blown onto the surface of the infrared-ray absorption layer 35 and room temperature impact consolidation is performed, the radiation suppression film 30 constituted by the ZnS porous body 31 and the infrared-ray absorption layer 35 can be formed on the surface of the stainless steel substrate 300.

Further, the radiation suppression film 30 may be formed by fixing a block formed by sintering fine particles of the base material 311 to the surface of substrate 300 on which the infrared-ray absorption layer 35 has been formed with an adhesive or the like. In this case, the porosity can be controlled by adjusting the particle diameter of the fine particles, the sintering temperature, and the sintering time.

The above is the description of the radiation suppression film 30 of the present example embodiment. The structure of FIG. 3 is an example, and the structure of the radiation suppression film 30 is not limited to the form as in FIG. 3. For example, the radiation suppression film 30 may be formed not on a flat surface but on a curved surface. The radiation suppression film 30 may be formed not on a smooth surface but on a surface having irregularities. The radiation suppression film 30 may be continuously or discontinuously formed on at least one surface of substrate 300. The radiation suppression film 30 may be formed on surfaces of the different substrates 300 so as to straddle a boundary between the substrates 300.

As described above, the radiation suppression film of the present example embodiment includes the infrared-ray absorption layer that absorbs the long wavelength infrared ray. As one aspect of the present example embodiment, the infrared-ray absorption layer is formed between the layer formed on at least a part of the surface of the substrate that radiates the long wavelength infrared ray and including the porous body, and the substrate.

The radiation suppression structure according to one aspect of the present example embodiment includes the infrared-ray absorption layer formed between the layer including the porous body and the substrate, and which absorbs the long wavelength infrared ray.

The radiation suppression film of the present example embodiment absorbs the long wavelength infrared ray radiated from the object surface by the infrared-ray absorption layer. The long wavelength infrared ray absorbed by the infrared-ray absorption layer is converted into heat or reradiated in any direction. The long wavelength infrared ray reradiated from the infrared-ray absorption layer is reradiated in the direction of the substrate or the direction of the porous body. The long wavelength infrared ray reradiated in the direction of the substrate is mainly converted into heat. The long wavelength infrared ray reradiated in the direction of the porous body is scattered by the holes, and a part of the long wavelength infrared ray is reabsorbed by an infrared-ray absorption film or the surface of the object and converted into heat. Therefore, the long wavelength infrared ray radiated from the surface of the substrate to the outside is reduced. Further, since the base material has high transparency in the long wavelength infrared region, thermal radiation of the base material itself in the long wavelength infrared region is small. Since these effects are synergized, when the surface of the object is covered with the radiation suppression film of the present example embodiment, the emissivity of the long wavelength infrared ray from the surface of the object can be reduced to less than 0.4.

### Fourth Example Embodiment

Next, a radiation suppression film according to a fourth example embodiment of the present invention will be described with reference to the drawing. The radiation suppression film of the present example embodiment has a structure in which the radiation suppression film of the second example embodiment is formed on the surface of the infrared-ray absorption layer of the third example embodiment. Hereinafter, description of structures, functions, and the like similar to those of the first to third example embodiments may be omitted.

[Structure]

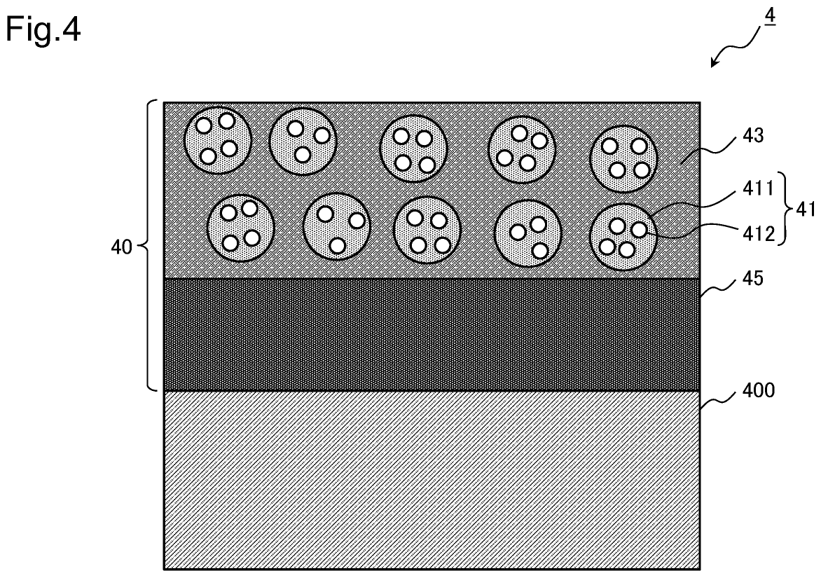

FIG. 4 is a conceptual diagram illustrating an example of a cross section of a radiation suppression structure 4 including a radiation suppression film 40 according to the present example embodiment. The radiation suppression film 40 including an infrared-ray absorption layer 45 and a resin 43 in which porous bodies 41 are dispersed is formed on a surface of a substrate 400. The porous body 41 has a structure in which holes 412 are dispersed inside a base material 411, similarly to the porous body 21 of the second example embodiment. The porous bodies 41 are dispersed inside the resin 43, similar to the resin 23 of the second example embodiment. The radiation suppression structure 4 is a structure in which the radiation suppression film 40 is formed on a surface portion of the substrate 400. In the present example embodiment, the radiation suppression film 40 is constituted by the porous bodies 41 in each of which the holes 412 are dispersed inside the base material 411, the resin 43 in which the porous bodies 41 are dispersed, and the infrared-ray absorption layer 45.

The base material 411 contains a material transparent to a long wavelength infrared ray, similar to the base material 211 of the second example embodiment. The material transparent to the long wavelength infrared ray is a material having high transmittance of the long wavelength infrared ray. Characteristics such as the material and physical properties of the base material 411 are similar to those of the base material 211 of the second example embodiment.

The hole 412 is a gap formed inside the base material 411, similarly to the hole 212 of the second example embodiment. The properties of the hole 412 are similar to those of the hole 212 of the second example embodiment.

The resin 43 is a base including the porous bodies 41 each having the dispersed holes 412 inside the base material 411. The resin 43 contains a material transparent to the long wavelength infrared ray. For example, polyethylene can be used as the resin 43. The thickness of the resin 43 is made larger than a wavelength in a long wavelength infrared region. The thickness of the resin 43 is favorably 10 times or more the wavelength in the long wavelength infrared region. Further, the thickness of the resin 43 is more favorably equal to or more than 500 μm.

An infrared-ray absorption layer 45 is formed on a surface of a substrate 400. A layer of the resin 43 in which the porous bodies 41 are dispersed is formed on an upper surface of the infrared-ray absorption layer 45. The infrared-ray absorption layer 45 is similar to the infrared-ray absorption layer 35 of the third example embodiment.

The substrate 400 is an object having the radiation suppression film 40 formed on its surface, similar to the substrate 100 of the first example embodiment. The infrared-ray absorption layer 45 is formed on the surface of the substrate 400.

[Manufacturing Method]

Next, a method for manufacturing the radiation suppression film 40 will be described with an example. For example, the radiation suppression film 40 can be manufactured by applying the resin 43 in which the porous bodies 41 each having the holes 412 dispersed inside the base material 411 are dispersed to the surface of the substrate 400 on which the infrared-ray absorption layer 45 has been formed.

First, fine particles of the base material 411 are sintered to produce a sintered body of the porous body 41. The porosity and the hole size of the sintered body of the porous body 41 can be controlled by adjusting the particle diameter of the fine particles, the sintering temperature, and the sintering time. Next, the sintered body of the porous body 41 is pulverized to produce particles of the porous body 41. Next, a coating material containing a material that absorbs the long wavelength infrared ray, such as a black body coating material, is applied to the surface of the substrate 400 to form the infrared-ray absorption layer 45. Next, the particles of the porous body 41 and the resin 43 are mixed to produce a coating material in which the particles of the porous body 41 are dispersed in the resin 43. Then, the coating material in which the particles of the porous body 41 are dispersed in the resin 43 is applied to the surface of the infrared-ray absorption layer 45 by a flow immersion method or the like and consolidated, so that the radiation suppression film 40 can be formed on the surface of the substrate 400.

For example, the infrared-ray absorption layer 45 is produced by applying a black body coating material to the surface of a stainless steel substrate 400. Further, a ZnS porous body 41 is produced by pulverizing a porous sintered body obtained by sintering fine particles of ZnS. A coating material is prepared by mixing the ZnS porous body 41 with a polyethylene resin 43. The coating material is applied to the surface of the stainless steel substrate 400 on which the infrared-ray absorption layer 45 has been formed by a flow immersion method and consolidated. The radiation suppression film 40 in which the ZnS porous bodies 41 are dispersed in the polyethylene resin 43 is laminated on the infrared-ray absorption layer 45 can be formed on the surface of the substrate 400 made of stainless steel.

The above is the description of the radiation suppression film 40 of the present example embodiment. The structure of FIG. 4 is an example, and the structure of the radiation suppression film 40 is not limited to the form as in FIG. 4. For example, the radiation suppression film 40 may be formed not on a flat surface but on a curved surface. The radiation suppression film 40 may be formed not on a smooth surface but on a surface having irregularities. The radiation suppression film 40 may be continuously or discontinuously formed on at least one surface of substrate 400. The radiation suppression film 40 may be formed on surfaces of the different substrates 400 so as to straddle a boundary between the substrates 400.

### Fifth Example Embodiment

Next, a radiation suppression film according to a fifth example embodiment of the present invention will be described with reference to the drawing. The radiation suppression film of the present example embodiment has a structure in which a protective layer is formed on a surface of a base material. In the present example embodiment, an example in which the protective layer is formed on the surface of the base material of the first example embodiment will be described, but the protective layer may be formed on the surface of the base material of the third example embodiment or on the surface of the resin of the second or fourth example embodiment. Hereinafter, description of structures, functions, and the like similar to those of the first example embodiment may be omitted.

[Structure]

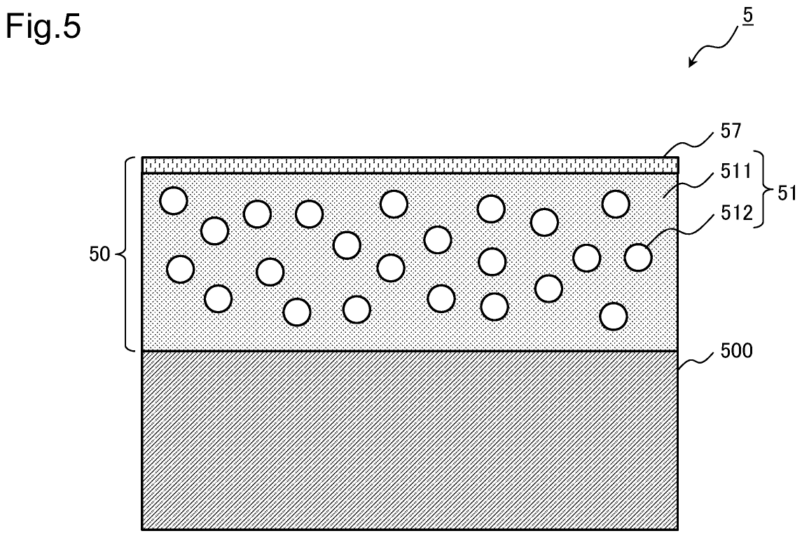

FIG. 5 is a conceptual diagram illustrating an example of a cross section of a radiation suppression structure 5 including a radiation suppression film 50 according to the present example embodiment. The radiation suppression film 50 including a porous body 51 and a protective layer 57 is formed on a surface of a substrate 500. The porous body 51 has a structure in which holes 512 are dispersed inside a base material 511, similarly to the porous body 11 of the first example embodiment. The radiation suppression structure 5 has a structure in which the porous body 51 is formed on a surface portion of the substrate 500, and the protective layer 57 is formed on a surface of the porous body 51. In the present example embodiment, the radiation suppression film 50 is constituted by the porous body 51 having the holes 512 dispersed inside the base material 511 and the protective layer 57.

The base material 511 contains a material transparent to a long wavelength infrared ray, similar to the base material 111 of the first example embodiment. The material transparent to the long wavelength infrared ray is a material having high transmittance of the long wavelength infrared ray. Characteristics such as the material and physical properties of the base material 511 are similar to those of the base material 111 of the first example embodiment.

The hole 512 is a gap formed inside the base material 511, similarly to the hole 112 of the first example embodiment. The properties of the hole 512 are similar to those of the hole 112 of the first example embodiment.

The protective layer 57 contains a material transparent to a long wavelength infrared ray. For example, the protective layer 57 is a thin film of an oxide or a fluoride having high transmittance of the long wavelength infrared ray. The protective layer 57 protects the base material 511 from deterioration due to wind and rain and high temperature. Examples of the material of the protective layer 57 include Al₂O₃, Y₂O₃, HfO₂, SiO₂, WO₃, TiO₂, ZrO₂, ZnO, CeO₂, Cr₂O₃, Ga₂O₃, Y₂O₃, CeF₃, LaF₃, YF₃, and ThF₄. Among the above materials, Y₂O₃, CeF₃, LaF₃, and YF₃ have high transparency in the long wavelength infrared ray and are suitable. For example, the protective layer 57 can be formed by sputtering, vacuum vapor deposition, a sol-gel method, a thermal spraying method, an aerosol deposition method, or the like. If the protective layer 57 is too thick, thermal radiation of the protective layer 57 itself interferes with stealth of the base material 511. The thickness of the protective layer 57 is not limited, but the thickness of the protective layer 57 is desirably equal to or less than 3 μm. In the case where the base material 511 contains a high refractive index material such as ZnS or ZnSe, the protective layer 57 favorably contains a low refractive index material. When the refractive index of the protective layer 57 is smaller than that of the base material 511, the protective layer 57 functions as an antireflection film and can suppress reflection of light from a surrounding environment on the surface of the radiation suppression film 50. Therefore, the stealth of the base material is improved. Examples of the low refractive index material include YF₃, ThF₄, LaF₃, CeF₃, Al₂O₃, and Y₂O₃.

The substrate 500 is an object having the radiation suppression film 50 formed on its surface, similar to the substrate 100 of the first example embodiment. The radiation suppression film 50 is formed on the surface of the substrate 500.

The above is the description of the radiation suppression film 50 of the present example embodiment. The structure of FIG. 5 is an example, and the structure of the radiation suppression film 50 is not limited to the form as in FIG. 5. For example, the radiation suppression film 50 may be formed not on a flat surface but on a curved surface. The radiation suppression film 50 may be formed not on a smooth surface but on a surface having irregularities. The radiation suppression film 50 may be continuously or discontinuously formed on at least one surface of substrate 500. The radiation suppression film 50 may be formed on surfaces of the different substrates 500 so as to straddle a boundary between the substrates 500.

As described above, the protective layer containing the material transparent to the long wavelength infrared ray is formed on the outermost surface of the radiation suppression film of the present example embodiment. According to the present example embodiment, the base material is protected by the protective layer from deterioration due to wind and rain and high temperature. For example, the protective layer has a smaller refractive index than the base material. When the refractive index of the protective layer is smaller than that of the base material, the protective layer functions as an antireflection film and can suppress reflection of light from a surrounding environment on the surface of the radiation suppression film.

### Sixth Example Embodiment

Next, a radiation suppression film according to a sixth example embodiment of the present invention will be described with reference to the drawing. The radiation suppression film of the present example embodiment has a configuration in which the radiation suppression films of the first to fifth example embodiments are simplified.

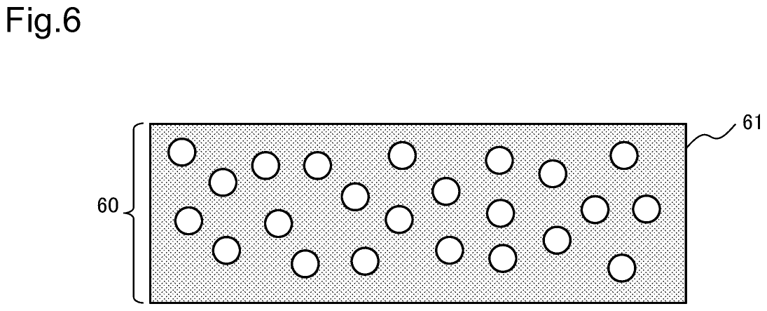

FIG. 6 is a conceptual diagram illustrating an example of a cross section of a radiation suppression film 60 of the present example embodiment. The radiation suppression film 60 includes a porous body 61 containing a material transparent to a long wavelength infrared ray as a base material.

According to the present example embodiment, the radiation suppression film that suppresses infrared radiation having a wavelength within a long wavelength infrared region and is less easily detected by a detection technique using a long wavelength infrared ray can be provided.

While the present invention has been described with reference to the example embodiments, the present invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2019-100505, filed on May 29, 2019, the disclosure of which is incorporated herein in its entirety by reference.

### REFERENCE SIGNS LIST

1, 2, 3, 4, 5 Radiation suppression structure
10, 20, 30, 40, 50, 60 Radiation suppression film
11, 21, 31, 41, 51, 61 Porous body
23, 43 Resin
35, 45 Infrared-ray absorption layer
100, 200, 300, 400, 500, 600 Substrate
111, 211, 311, 411, 511, 611 Base material
112, 212, 312, 412, 512 Hole

What is claimed is:

1. A radiation suppression film comprising:
a porous body containing a material transparent to a long wavelength infrared ray as a base material.

2. The radiation suppression film according to claim 1, wherein the base material contains at least one of materials selected from a group of ZnSe, ZnS, and Ge.

3. The radiation suppression film according to claim 1, wherein the material of the base material contains polyethylene.

4. The radiation suppression film according to claim 1, comprising:
a layer of the porous body.

5. The radiation suppression film according to claim 1, having a structure in which the porous bodies are dispersed in a resin containing a material transparent to a long wavelength infrared region.

6. The radiation suppression film according to claim 5, wherein the material of the resin contains polyethylene.

7. The radiation suppression film according to claim 1, comprising:
an infrared-ray absorption layer that absorbs the long wavelength infrared ray.

8. The radiation suppression film according to claim 7, wherein
the infrared-ray absorption layer is formed between a layer formed on at least a part of a surface of a substrate that radiates the long wavelength infrared ray and including the porous body and the substrate.

9. The radiation suppression film according to claim 1, wherein a protective layer transparent to the long wavelength infrared ray is formed on an outermost surface.

10. A radiation suppression structure comprising:
a substrate; and
the radiation suppression film according to claim 1, wherein
the radiation suppression film is formed on at least a part of the substrate.
